(19) United States
(12) Patent Application Publication
(10) Pub. No.: US 2007/0241913 A1
(43) Pub. Date: Oct. 18, 2007

(54) HUNTER PROXIMITY DETECTION SYSTEM

(76) Inventor: Paul S. Langenfeld, St. Paul, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/566,374

(22) Filed: Dec. 4, 2006

Related U.S. Application Data
(60) Provisional application No. 60/744,962, filed on Apr. 17, 2006.

(51) Int. Cl. G08B 23/00

(52) U.S. Cl. 340/573.2

(57) ABSTRACT

A system for facilitating the protection of hunters in a particular geographic area. The system includes a transmitter/receiver unit carried by each hunter in a particular area. Such units enable the hunters to ensure that proximate hunters are beyond a defined safe distance in view of type of weapons being utilized and other factors.

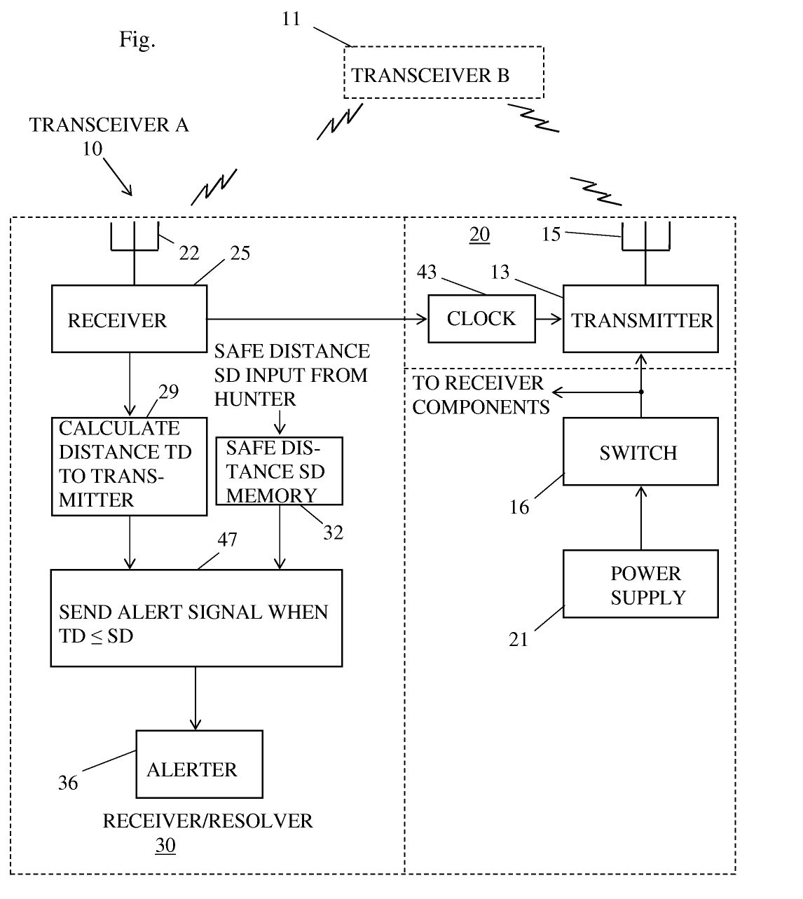

### CROSS-REFERENCE TO RELATED APPLICATIONS

This is a regular application filed under 35 U.S.C. § 111(a) claiming priority, under 35 U.S.C. § 119(e) (1), of provisional application Ser. No. 60/744,962, previously filed Apr. 17, 2006 under 35 U.S.C. § 111(b).

### TECHNICAL FIELD

The present invention deals broadly with the field of detecting spacing between two objects or persons. More narrowly, however, the invention deals with proximity detection between two hunters. In a preferred embodiment, the invention focuses upon apparatus for detecting excessively close proximity between two hunters.

### BACKGROUND OF THE INVENTION

Hunting with firearms has always entailed the possibility of inadvertently shooting in the direction of other hunters. Rifles used in hunting are particularly dangerous because of their long range, and because rifle hunting often occurs in wooded terrain where visibility is limited.

On occasion, this situation results in injury or death. To minimize such tragedies, over the years, a whole set of gun safety rules have been developed which, if always followed, reduce the possibility of hunting accidents to near zero. Additionally, hunters can, in some types of hunting, wear high-visibility clothing, which further reduces the possibility of hunting accidents. In some other types of hunting, however, it is not only desirable for the hunter to not make himself conspicuous by wearing high-visibility clothing, but it is expressly intended that the hunter be camouflaged. For example, in duck hunting it is desirable to blend in with the surrounding as much as possible so that detection of the hunter by the prey will be unlikely. However, human nature being what it is, hunting accidents still do occur far too often.

### SUMMARY OF THE INVENTION

The present invention is apparatus for improving the safety of hunters. Particularly, it is apparatus for rendering safe adjacent hunters in a particular geographic area. The apparatus includes a transmitter carried by a first hunter. The transmitter transmits a coded signal at regular time intervals. A receiver is carried by a second hunter. The receiver is tuned to detect and receive the coded signal transmitted by the transmitter of the first hunter. Certain parameters are defined, the parameters having to be met prior to detection of a situation initiating an alarm. The alarm cooperates with the receiver and is configured to alert the second hunter when the coded signal is detected. Upon activation of the alarm, the hunter carrying the receiver becomes aware that another hunter is within a dangerous proximity to him.

In a preferred embodiment of the invention, a system is envisioned wherein each hunter in a designated geographic area would wear or carry a transmitter/receiver unit. The safety of all hunters would, therefore, be reciprocal. That is, such a system would protect all hunters in a defined location.

A preferred embodiment of the invention includes structure to enable the hunters to define a safe distance depending on various criteria. The safe distance can thereby be varied depending upon range of weapons utilized and other factors.

The present invention is thus an improved system and apparatus for employment in protecting hunters. More specific features and advantages obtained in view of those features will become apparent with reference to the DETAILED DESCRIPTION OF THE INVENTION, appended claims and accompanying drawing figures.

### BRIEF DESCRIPTION OF THE DRAWINGS

The drawing FIGURE is a block diagram of a transmitter/receiver unit in accordance with the present invention.

### DETAILED DESCRIPTION OF THE INVENTION

The FIGURE shows a block diagram of a transmitter/receiver unit A 10 and a second identical transmitter/receiver unit B 11. Each hunter in the field would, it is envisioned, carry a single transmitter/receiver unit 10. The transmitter/receiver unit 10 may be mounted on the weapon or attached to the hunter. The transmitter/receiver unit 10 must be carried in a way that allows for notifying the hunter when a transmitter/receiver unit 11 is closer than a selectable safe distance SD from transmitter/receiver unit 10.

Each transmitter/receiver unit 10 or 11 comprises a transmitter section 20, a receiver/resolver 30, and a power supply providing electrical power for the other components. Transmitter section 20 includes a transmitter 13, a clock 43, and a transmitting antenna 15. Receiver/resolver 30 includes a receiver 25, a distance calculator 29, a memory element 32 for storing the SD value, a comparator 47, and an alarm 36.

The transmitter 13 transmits a short coded signal at intervals, for example, of 1 to 5 sec. on an antenna 15. The signal is very short compared to the interval length, and encodes a time stamp provided by clock 43.

The receiving antenna 22 and receiver 25 in a second transponder unit B 11 nearby receives the signals transmitted by all nearby transmitter/receiver units. In one embodiment, the receiver 25 demodulates the signal and transmits the demodulated signal including the time stamp to a distance calculator 29. The distance calculator 29 computes the difference in nanoseconds between the current time and the time encoded in the received signal, which is the elapsed time for the signal to reach the receiver 25. Calculator element 25 then multiplies the elapsed time in ns. by 0.982 to yield the distance TD to the transmitting transmitter/receiver unit 11. (Light travels 0.982 ft./ns.)

A memory element 32 stores the safe distance value SD, which is the distance that another hunter must be from transmitter/receiver unit A 10 to be considered safe. In one version, individual hunters can enter the safe distance value SD into memory element 32. Another version may have a preselected SD value, say 600 ft., stored in memory element 32. Means can be employed, based upon the nature of the prey being hunted and the type of weapon used in such hunting, to input a safe distance. The determinant criterion, therefore, is the type of prey, and input means can be a function of such a factor.

The comparator 47 receives the TD and SD values. When TD≦SD, comparator 47 sends an alert signal to alarm 36. Alarm 36 then produces a warning sound, light, or vibration for the hunter carrying transmitter/receiver unit A 10. A similar warning event occurs almost simultaneously with transmitter/receiver unit B 11. This warning notifies each hunter carrying a transmitter/receiver unit that another hunter is within a dangerous distance in view of the firearm being used. Thus, each hunter knows to hold his or her fire until absolutely sure of the other hunter's location.

A version of each transmitter/receiver unit 10 may include a synchronizing feature, such that, when a receiver 25 receives and decodes a signal, the receiver 25 immediately updates clock 43 in its transmitter/receiver unit with the decoded time stamp. The transmitter 13 then sends a signal including the updated time stamp, so that the clock 43 in each of the transmitter/receiver units A and B 10, 11 holds synchronized time values.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. Apparatus for improving the safety of hunters, comprising:
(a) a transmitter carried by a first hunter, said transmitter transmitting a coded signal at regular intervals;
(b) a receiver carried by a second hunter, said receiver tuned to detect said coded signal when certain defined parameters are met; and
(c) an alarm cooperating with said receiver and configured to alert the second hunter when said coded signal is detected.

2. Apparatus in accordance with claim 1 further comprising means for selectively defining a safe distance between the first and second hunters, wherein, when the actual distance between the first and second hunters exceeds said safe distance, said alarm will not alert the second hunter.

3. Apparatus in accordance with claim 2 further comprising a clock cooperating with said transmitter to enable said coded signal to be transmitted at a desired interval.

4. Apparatus in accordance with claim 3 further comprising means for demodulating said coded signal and a distance calculator to which a demodulated signal is transmitted from said receiver.

5. Apparatus in accordance with claim 4 further comprising means for comparing the actual distance between the first and second hunters and the selectively defined safe distance.

6. A hunter safety system, comprising:
a transmitter/receiver unit carried by each hunter in a particular geographic area, each transmitter/receiver unit comprising a transmitter which transmits a coded signal at the same frequency and interval of signals transmitted by transmitter/receiver units of other hunters in the geographic area, a receiver tuned to detect said coded signal when certain defined parameters are met, and an alarm cooperating with the receiver of each of said units to alert a hunter when a coded signal of the transmitter/receiver unit of another hunter in the geographic area is detected.

7. Apparatus in accordance with claim 6 wherein each transmitter/receiver unit carried by a hunter in the geographic area further comprises means for selectively defining a safe distance between two hunters, and, wherein, when the actual distance between two hunters exceeds said safe distance, said alarm will not alert either of the hunters.
